(19) United States
(12) Patent Application Publication
(10) Pub. No.: US 2013/0015723 A1
(43) Pub. Date: Jan. 17, 2013

(54) Safe Switch System and Method

(71) Applicant: Mark A. DiLuciano, Amherst, OH (US)

(72) Inventor: Mark A. DiLuciano, Amherst, OH (US)

(73) Assignee: JOHNSON INDUSTRIES, INC., Pikeville, KY (US)

(21) Appl. No.: 13/352,378

(22) Filed: Jan. 18, 2012

Related U.S. Application Data
(60) Provisional application No. 61/461,284, filed on Jan. 18, 2011.

(51) Int. Cl. H01H 47/00

(52) U.S. Cl. 307/143

(57) ABSTRACT

An apparatus comprises an enclosure, an electronic switch, and a solar panel. The enclosure is operable to house electronic components and is configured to be explosion proof. The electronic switch is in communication with the enclosure and the solar panel. The solar panel is operable to deliver power to the electronic switch without accumulating charge. The solar panel is further configured to deliver power to the electronic switch without generating any sparks.

### PRIORITY

This application claims priority to U.S. Provisional Patent Application Ser. No. 61/461,284, filed Jan. 18, 2011, entitled “Intrinsically Safe Switch System,” the disclosure of which is incorporated by reference herein.

### BACKGROUND

In some industries, which may include, for example, drilling or construction, it will be appreciated that switches, particularly electrical switches, may be used for the operation of certain types of machinery or other components. It will further be understood that in some environments, the use of some electrical switches may pose dangers. Using some electrical switches can produce sparks simply during the normal operation of the switches. In the event that a spark occurs in the presence of some combustive or otherwise dangerous gases, the spark could ignite the gases thereby causing an explosion, or worse. Inadvertent sparks could also have other dangerous and/or undesirable effects.

In other scenarios, even if switches themselves do not cause sparks, short circuits occurring in or around the wiring of the switches could potentially ignite surrounding gases, which could also create a dangerous and/or undesirable situation. In some scenarios, a low wattage DC/DC converter may be used in an attempt to reduce the danger of sparks, etc. However, conventional DC/DC converters may utilize batteries, capacitors, and/or other components capable of discharging sufficient power to inadvertently cause a spark, therefore still posing a danger to the equipment or anything nearby the switch.

It will be appreciated that in some cases, an explosion proof enclosure may be used to reduce the risk of an explosion. In such cases, however, the enclosure itself may be cumbersome and/or expensive. The use of such explosion proof enclosures may also require the use of extensive cables, levers, or other components with the enclosure, which may be cumbersome to use, expensive to produce, and time consuming to fabricate. As a result, such explosion proof enclosures may be undesirable or impractical for a particular operation.

While a variety of safe switches have been made and used, it is believed that no one prior to the inventor has made or used an invention as described herein.

### BRIEF DESCRIPTION OF THE DRAWINGS

While the specification concludes with claims which particularly point out and distinctly claim the invention, it is believed the present invention will be better understood from the following description of certain examples taken in conjunction with the accompanying drawings, in which like reference numerals identify the same elements and in which:

FIG. 1 depicts a block diagram view of an exemplary version of a safe switch system;

FIG. 2 depicts a diagrammatic view of an alternative exemplary version of a safe switch system; and

FIG. 3 depicts a schematic view of yet another alternative exemplary version of a safe switch system.

The drawings are not intended to be limiting in any way, and it is contemplated that various embodiments of the invention may be carried out in a variety of other ways, including those not necessarily depicted in the drawings. The accompanying drawings incorporated in and forming a part of the specification illustrate several aspects of the present invention, and together with the description serve to explain the principles of the invention; it being understood, however, that this invention is not limited to the precise arrangements shown.

### DETAILED DESCRIPTION

The following description of certain examples of the invention should not be used to limit the scope of the present invention. Other examples, features, aspects, embodiments, and advantages of the invention will become apparent to those skilled in the art from the following description, which is by way of illustration, one of the best modes contemplated for carrying out the invention. As will be realized, the invention is capable of other different and obvious aspects, all without departing from the invention. Accordingly, the drawings and descriptions should be regarded as illustrative in nature and not restrictive.

In some scenarios, it will be appreciated that electronic switches may be used to control, interact, and/or engage other suitable components. In some situations, which may involve flammable and/or combustible gases, it will be appreciated that it may be desirable to have an electronic switch resistant or constructed such that operation of the electronic switch does not cause any sparks, which may ignite, therefore potentially causing a fire or explosion.

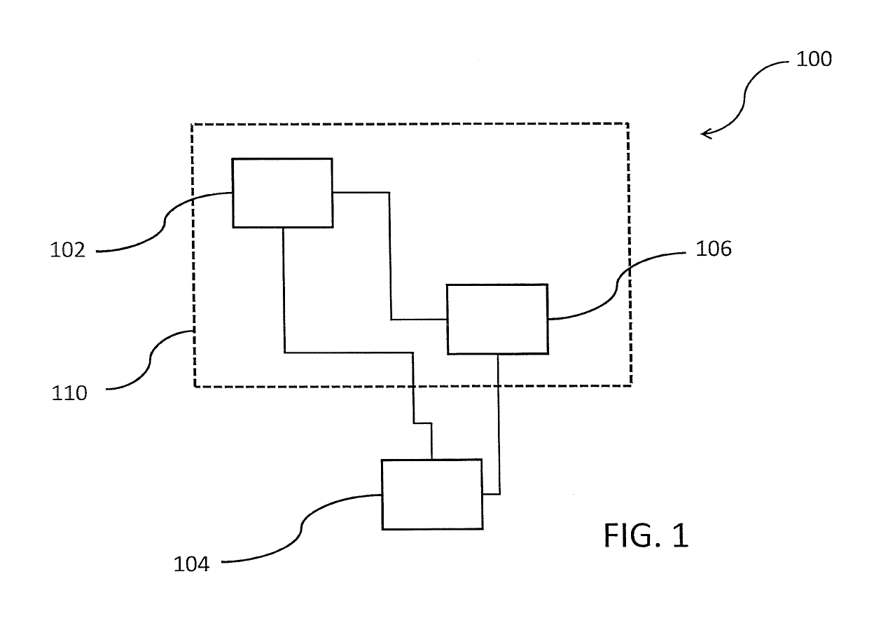

FIG. 1 shows an exemplary safe switch system (100). Safe switch system (100) comprises an enclosure (110) having a power source (102) and other electronic components (106). Enclosure (110) is in communication with a switch (104). Enclosure (110) in the illustrated version may comprise, for example, an explosion proof casing, which may be constructed of, for example, plastic and/or metal, or any other suitable material as would be apparent to one of ordinary skill in the art in view of the teachings herein. In the exemplary version, enclosure (110) is operable to withstand fire, explosions, or other potential dangers. Enclosure (110) may be further constructed to be a single molded component, or may be constructed of multiple parts and later combined to form enclosure (110). Other suitable constructions for enclosure (110) will be apparent to one of ordinary skill in the art in view of the teachings herein.

Power source (102) in the exemplary version comprises a solar panel operable to convert solar energy into electrical energy. Power source (102) is in communication with electronic components (106) and is in further communication with switch (104). In the exemplary version, it will be appreciated that switch (104) is externally located and operable to engage the components contained within enclosure (110). In the exemplary version, switch (104) is moveable between an “on” and “off” state, but it will be appreciated that in some versions switch (104) may be switchable between multiple positions as will be apparent to one of ordinary skill in the art. In some versions, rather than switch (104) being in communication with enclosure (110) by itself, other components may be in communication with enclosure (110) in addition to switch (104). Furthermore, it will be appreciated that power source (102) is operable to provide power to electronic components (106) at a sufficiently low power level such that power source (102) does not create any sparks. In some versions, it will also be appreciated that power source (102) is operable to provide power to electronic components (106) without accumulating charge, which could otherwise result in an explosion depending on the surrounding environment. While in the exemplary version power source (102) comprises a solar panel, it will be appreciated that other sources of power may be used as would be apparent to one of ordinary skill in the art in view of the teachings herein. For example, power source (102) in some merely exemplary versions may comprise one or more thermocouples configured for use with safe switch system (100).

In the exemplary version, electronic components (106) may comprise any suitable components as would be apparent to one of ordinary skill in the art in view of the teachings herein. For example, electronic components (106) may comprise isolators, fuses, relays, etc., or any other suitable components. Exemplary electronic components will be discussed in further detail below.

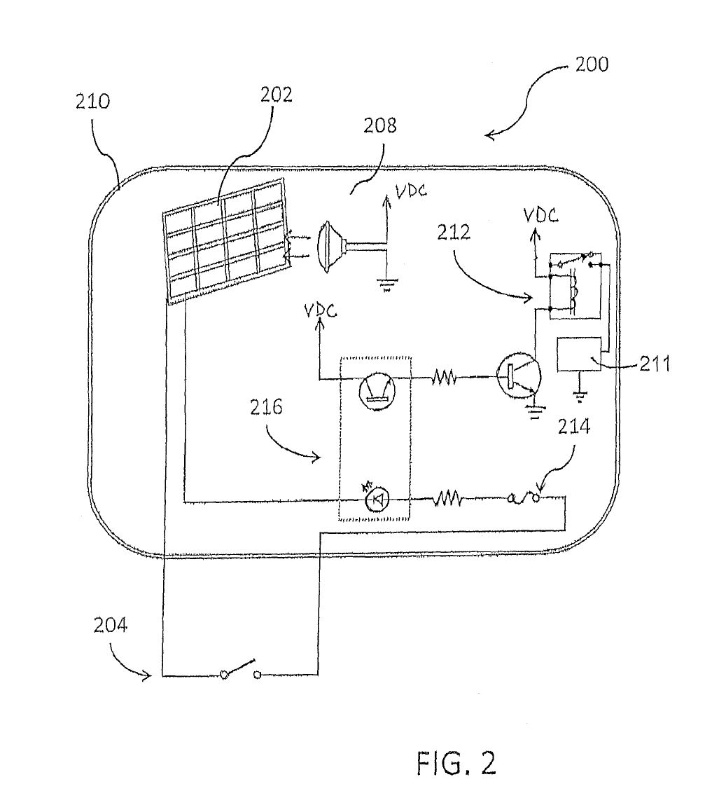

FIG. 2 shows another exemplary version of a safe switch system (200) comprising a switch (204) and an enclosure (210). Enclosure (210) comprises a solar panel (202) with a light source (208). Solar panel (202) is in communication with switch (204) and an optical isolator (216). Optical isolator (216) is in communication with a relay (212). In the exemplary version, optical isolator (216) is in communication with relay (212) through a transistor, but it will be appreciated that in some exemplary versions, optical isolator (216) may connect directly to relay (212) or through an alternative suitable component and/or components.

Solar panel (202) in the exemplary version is operable to provide approximately 6 volts, 50 mA, and 0.3 watts of energy. It will be appreciated that other suitable power rates may be provided by solar panel (202) as would be apparent to one of ordinary skill in the art in view of the teachings herein. The illustrated version shows a single solar panel (202) being used in safe switch system (200), but in other exemplary versions, any suitable number of solar panels (202) may be used as would be apparent to one of ordinary skill in the art in view of the teachings herein. For example, an array or other suitable arrangement of solar panels (202) may be used. Furthermore, solar panel (202) may have any suitable size and/or construction. For example, solar panel (202) may be small and compact or solar panel (202) may be large, having a large surface area depending on the requirements of a particular application. Light source (208) in the illustrated version comprises an LED lamp operable to provide light to solar panel (202) such that solar panel (202) can convert light into electricity for delivery to other parts of safe switch system (200). In other versions, it will be appreciated that any suitable components may be used for light source (208) as would be apparent to one of ordinary skill in the art in view of the teachings herein. For example, natural light, incandescent bulbs, or other suitable light sources may be used for light source (208).

In the exemplary version, solar panel (202) is operable to deliver power to optical isolator (216), which then is operable to power relay (212). Relay (212) may then be used to provide switching for any suitable component as would be apparent to one of ordinary skill in the art in view of the teachings herein. The illustrated version shows relay (212) in communication with a powered component (211), which may represent any suitable powered component, such as front and rear lights, strobe lights, horns, motor, power steering, or any other suitable components. In yet other versions, relay (212) may be in communication with various suitable internal components as well, such as a motor controller, reversing contactor, battery monitor, panic switch, or any other suitable components. It will further be appreciated that while relay (212) is in communication with a single powered component (211) in the version illustrated in FIG. 2, in other versions relay (212) may be in communication with any suitable number of external and/or internal components. Furthermore, while the exemplary version shows all of the various components contained in a single enclosure (210), it is contemplated that parts of safe switch system (200) may be contained in more than one enclosure (210).

In the illustrated version, fuse (214) is utilized to prevent excess current from traveling to optical isolator (216). Optical isolator (216) is operable to provide as much as 5,000 volts of voltage isolation. In other versions, optical isolator (216) may be selected to have any suitable specification. In the illustrated version, a 50 mA fuse (214) is used, but in other versions, any suitable fuse (214) may be used as would be apparent to one of ordinary skill in the art in view of the teachings herein. In yet other exemplary versions, fuse (214) may be omitted entirely or otherwise configured as would be apparent to one of ordinary skill in the art. In the exemplary version, fuse (214) is selected to substantially match the output of solar panel (202), but in other exemplary versions, it will be appreciated that any suitable fuse specification may be used. It will also be appreciated that while the illustrated version shown in FIG. 2 has a single fuse (214), relay (212), optical isolator (216), light source (208), and solar panel (202), any suitable number of the above mentioned components may be used as would be apparent to one of ordinary skill in the art. It will be understood that the use of one of the each of the above mentioned components in FIG. 2 is merely exemplary and for illustrative purposes only.

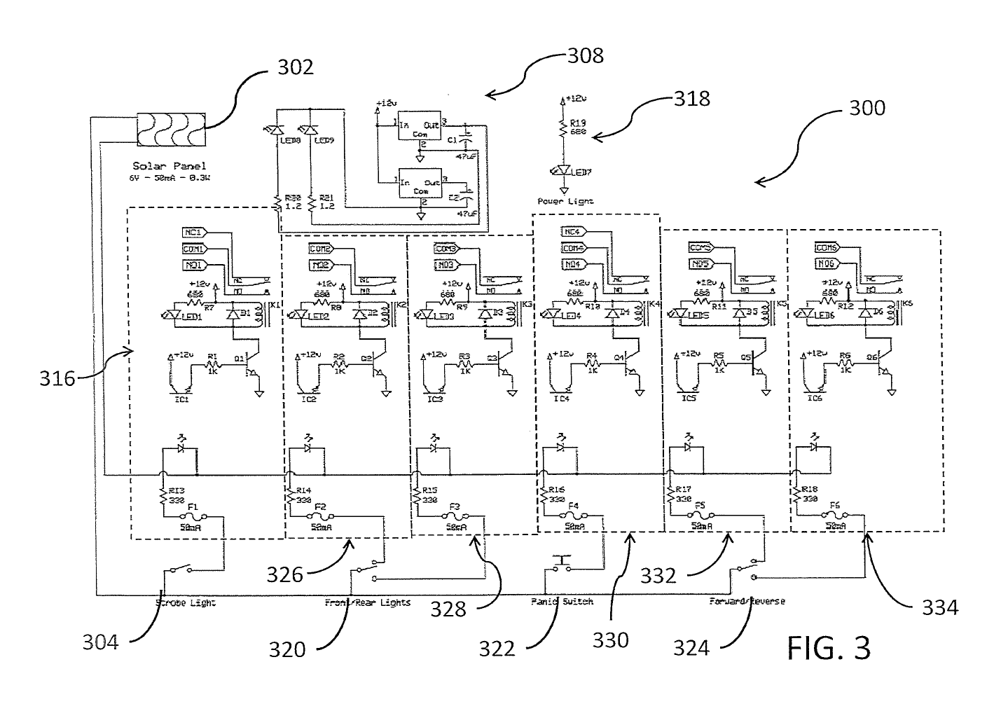

FIG. 3, for example, shows an exemplary version of a safe switch system (300) implementing multiple switches (304, 320, 322, 324), in communication with solar panel (302) and in further communication with a series of optical isolators and relays (316, 326, 328, 330, 332, 334). Solar panel (302) in the illustrated version is powered by light source (308), which comprises two LEDs. Of course, while the illustrated version shows two LEDs, it will be appreciated that any suitable number of LEDs may be used. The illustrated safe switch system (300) further includes a power light (318) operable to visibly show whether charge is flowing through safe switch system (300). For example, power light (318) may be configured to be on when current is flowing through safe switch system (300) and off when current no longer flows through safe switch system (300). In other exemplary versions, rather than power light (318) another indicator, such as a textual display, LED display, sound, or other indicator may be used to indicate the status of safe switch system (300). In other versions, power light (318) may be omitted entirely. Power light (318) may also be operable to convey diagnostic information regarding safe switch system (300). Other variations will be apparent to one of ordinary skill in the art in view of the teachings herein.

Switches (304, 320, 322, 324) are operable to control a variety of functions and associated components by being in communication with optical isolators and relays (316, 326, 328, 330, 332, 334). For example, switch (304) may be operable to control a strobe light. Switch (320) may be operable to control front and/or rear lights. Switch (322) may be operable to control a panic switch. Switch (324) may be operable to control a forward and/or reverse functionality. It will be understood that these exemplary switches (304, 320, 322, 324) are merely illustrative and in other versions, switches may be configured to control various other functionalities and components which will be apparent to one of ordinary skill in the art in view of the teachings herein.

It will be understood that the illustrated versions of switch system (100, 200, 300) shown in FIGS. 1-3 contain selected components that are merely exemplary. For example, resistors, voltages, power supplies, transistors, capacitors, inductors, fuses, LEDs, switches, relays, control modules, or any other suitable components may be selected having a variety of specifications including those shown in the illustrated versions, provided the overall switch system is still operable to operate without causing any sparks or building up excess charge capable of igniting volatile gases. However in some other exemplary versions, other suitable values and specifications may be selected. For examples, resistors may be selected to have any suitable value, and those shown in FIG. 3 are merely exemplary. Other suitable values may be used as would be apparent to one of ordinary skill in the art in view of the teachings herein.

As a result, safe switch system (100, 200, 300) may be integrated into a larger system to operate the switching for various components within the larger system. It will be appreciated that safe switch system (100, 200, 300) may be operable to provide power without creating sparks or without providing any accumulation of charge sufficient to cause an ignition and/or an explosion in the event that safe switch system (100, 200, 300) is used in or around flammable gases. It will further be understood that multiple safe switch systems (100, 200, 300) may be integrated into a larger system and configured to operate many functionalities within the larger system.

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometries, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

I/We claim:

1. An apparatus comprising:
(a) an enclosure operable to house electronic components, wherein the enclosure is configured to be explosion resistant;
(b) an electronic switch in communication with the enclosure; and
(c) a solar panel in communication with the electronic switch, wherein the solar panel is configured to deliver power to the electronic switch, wherein the solar panel is configured to deliver power to the electronic switch without accumulating charge, wherein the solar panel is further configured to deliver power to the electronic switch without generating any sparks.

2. The apparatus of claim 1, wherein the solar panel is operable to provide approximately 50 mA of current to the electronic switch.

3. The apparatus of claim 1, wherein the solar panel is operable to provide approximately 0.3 watts of power to the electronic switch.

4. The apparatus of claim 1, wherein the output of the solar panel does not exceed 6V.

5. The apparatus of claim 1, wherein the electronic switch comprises a relay.

6. The apparatus of claim 1, further comprising an optical isolator in communication with the solar panel.

7. The apparatus of claim 1, further comprising a light source operable to power the solar panel.

8. The apparatus of claim 7, wherein the light source comprises at least one LED.

9. The apparatus of claim 1, further comprising a fuse in communication with the electronic switch.

10. The apparatus of claim 9, wherein the fuse is configured to substantially match the output of the solar panel.

11. An apparatus comprising:
(a) an explosion proof enclosure;
(b) a power source contained within the explosion proof enclosure; and
(c) an electronic component in communication with the power source, wherein the power source is operable to deliver power to the electronic component, wherein the power source is configured to deliver power to the electronic component without accumulating charge.

12. The apparatus of claim 11, wherein the power source is configured to deliver power to the electronic component without producing any sparks.

13. The apparatus of claim 11, wherein the electronic component comprises at least one relay.

14. The apparatus of claim 13, wherein the electronic component comprises two or more relays.

15. The apparatus of claim 11, wherein the power source comprises at least one solar panel powered by at least one light source.

16. The apparatus of claim 15, wherein the at least one light source comprises at least one LED light.

17. A power source for use with at least one electronic switch comprising:
(a) at least one LED;
(b) at least one solar panel, wherein the at least one LED is operable to deliver light energy to the at least one solar panel;
wherein the power source is configured to deliver power to the at least one electronic switch in such a way that the energy is provided by the power source in a non-combustible manner.

18. The power source of claim 17, further comprising a fuse pre-selected to be substantially matched to the current provided by the power source.

19. The power source of claim 17, wherein the at least one electronic switch comprises a relay.

20. The power source of claim 17, wherein the power source is operable to provide approximately 50 mA of current to the at least one electronic switch.
